(19) United States
(12) Patent Application Publication
(10) Pub. No.: US 2013/0094899 A1
(43) Pub. Date: Apr. 18, 2013

(54) LOCKING APPARATUS

(71) Applicant: Chen-Lu FAN, Tu-Cheng (TW)

(72) Inventor: Chen-Lu FAN, Tu-Cheng (TW)

(73) Assignee: HON HAI PRECISION INDUSTRY CO., LTD., Tu-Cheng (TW)

(21) Appl. No.: 13/517,882

(22) Filed: Jun. 14, 2012

(30) Foreign Application Priority Data
Oct. 14, 2011 (TW) 100137406

(51) Int. Cl. F16B 21/02

(52) U.S. Cl. 403/323

(57) ABSTRACT

A locking apparatus includes a positioning member attached to a first device and a securing member rotatably attached to a second device. The securing member defines a guiding slot and a positioning slot communicating with the guiding slot. The securing member is rotatable about an axis substantially perpendicular to the electronic device, and the positioning member is passed along the guiding slot to engage in the positioning slot, for preventing the first device being moved away from the second device.

### BACKGROUND

1. Technical Field

The present disclosure relates to locking apparatuses, particularly to a locking apparatus for securing a first device to a second device.

2. Description of Related Art

Blade and rack-mounted servers are popular form factors for data center servers. In order to achieve high performance, many rack-mounted servers are clustered in an enclosure. The rack-mounted servers are usually secured together by screws. However, using screws to secure the rack-mounted servers is very laborious and time-consuming. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a locking apparatus, a first device and a second device in accordance with an embodiment.

FIG. 2 is an exploded, isometric view of the locking apparatus of FIG. 1.

FIG. 3 is an assembled view of the items of FIG. 1.

FIG. 4 is a cross-sectional view of FIG. 3, taken along a line IV-IV.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

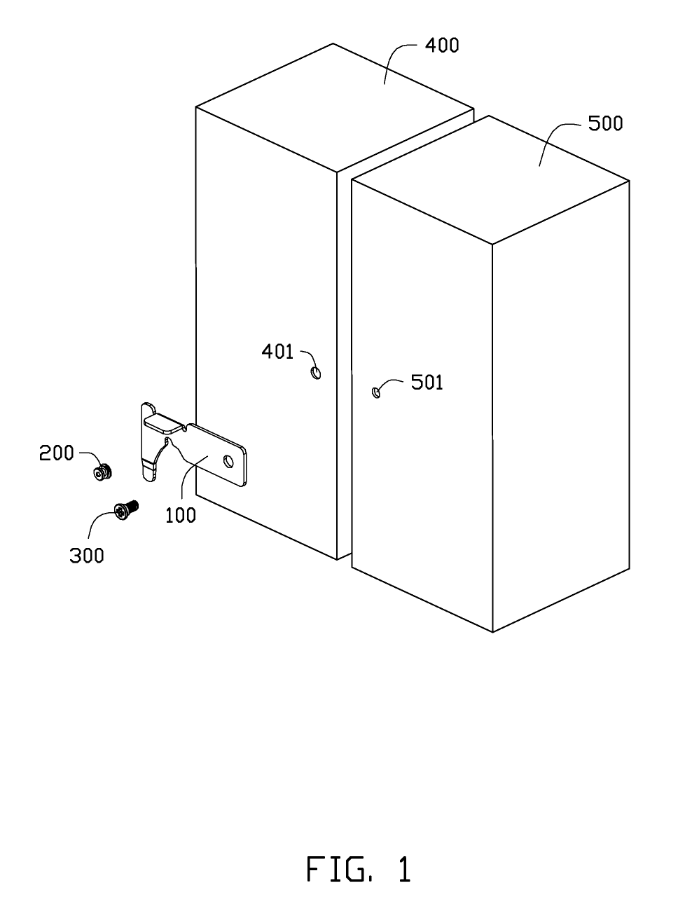

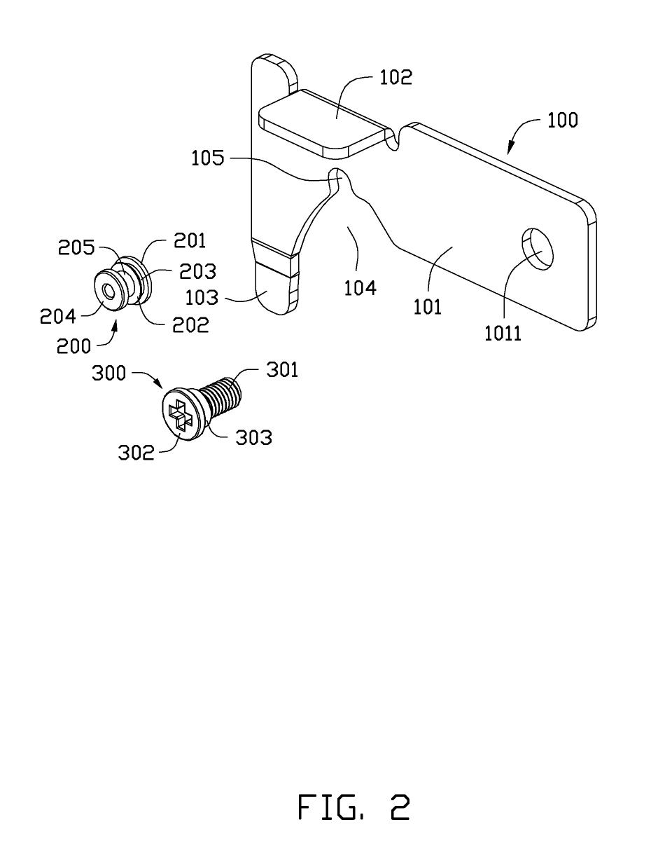

Referring to FIGS. 1 and 2, a locking apparatus in accordance with an embodiment includes a securing member 100, a positioning member 200, and a mounting member 300 attached to the securing member 100. In one embodiment, the locking apparatus is used to secure a first device 400 to a second device 500. The first device 400 defines a positioning hole 401, and the second device 500 defines a fixing hole 501. In one embodiment, the first and second devices 400, 500 are server racks.

The securing member 100 includes a securing panel 101, an operating tab 102 extending from the securing panel 101, and a blocking panel 103 connected to securing panel 101. In one embodiment, the securing panel 101 is substantially perpendicular to the blocking panel 103. A securing hole 1011 is defined in the securing panel 101. In one embodiment, the operating tab 102 is substantially perpendicular to the securing panel 101. A guiding slot 104 and a positioning slot 105 are defined in the securing panel 101. The guiding slot 104 communicates with the positioning slot 105, and a size of the guiding slot 104 is greater than that of the positioning slot 105.

The positioning member 200 includes a first positioning portion 201, a second positioning portion 202, a third positioning portion 204, a first connecting portion 203, and a second connecting portion 205. The first connecting portion 203 is connected to the first positioning portion 201 and the second positioning portion 202, and the second connecting portion 203 is connected to the second positioning portion 202 and the third positioning portion 204. A length of the first connecting portion 203 is less than the length of the second connecting portion 205. A diameter of the first positioning portion 201 is greater than a diameter of the second positioning portion 202.

The mounting member 300 includes a head 302, a stud 301, and a connecting portion 303 connected to the head 302 and the stud 301. In one embodiment, a diameter of the connecting portion 303 is less than a diameter of the head 302, and greater than a diameter of the stud 301.

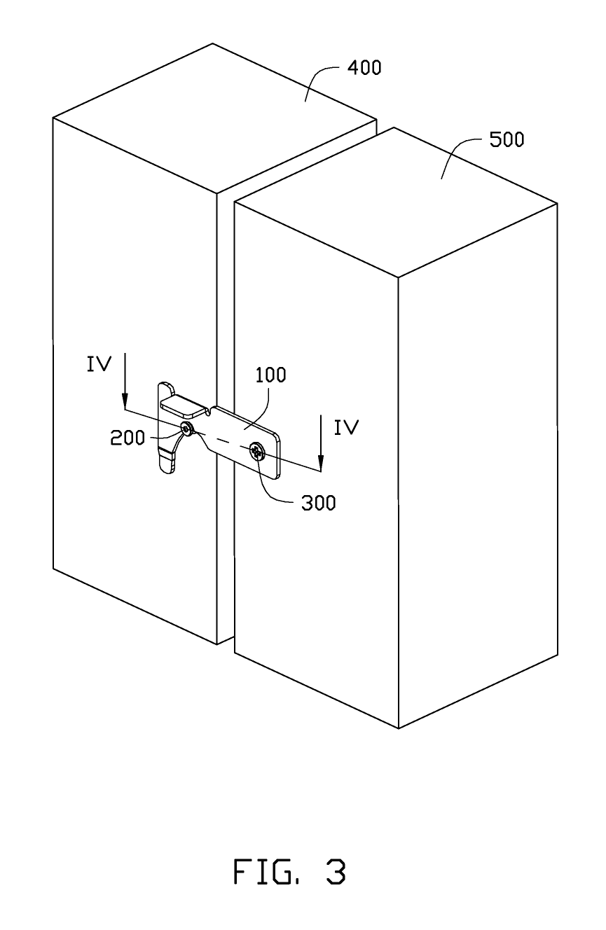

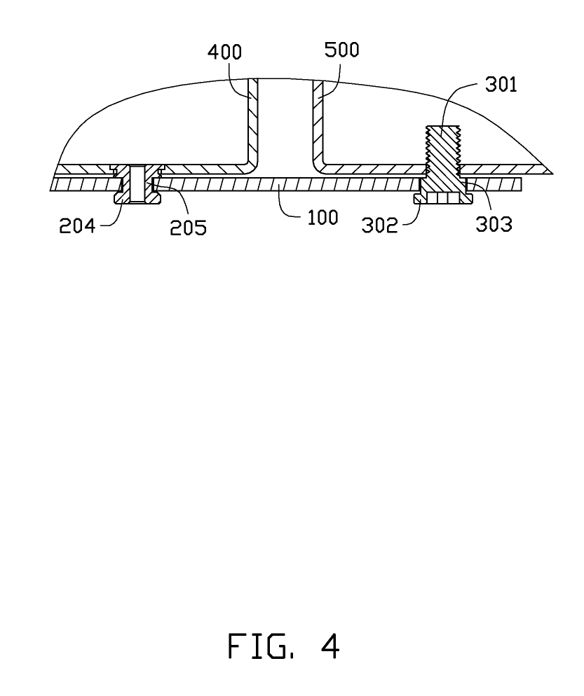

Referring to FIGS. 3 and 4, in assembly, the first positioning portion 201 and the first connecting portion 203 are engaged in the positioning hole 401, and the second positioning portion 202 extends out of the positioning hole 401. Thus, the positioning member 200 is secured to the first device 400.

The securing member 100 abuts the second device 400. The securing hole 1011 is aligned with the fixing hole 501. The stud 301 and the connecting portion 303 are engaged in the fixing hole 501, to rotatably secure the securing member 100 to the second device 500 via the mounting member 300.

In coupling the first device 400 to the second device 500, the securing member 100 is rotated about the mounting member 300 relative to the second device 500 in a first direction, until the positioning member 200 passes along the guiding slot 104 to engage in the positioning slot 105. The first device 400 is secured to the second device 500 when the second connecting portion 205 engages with the positioning slot 105.

In disassembly of the first device 400 from the second device 500, the securing member 100 is rotated about the mounting member 300 relative to the second device 500 in a second direction opposite to the first direction, until the second connecting portion 205 is disengaged from the guiding slot 104. The first device 400 can now be detached and removed from the second device 500.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A locking apparatus to secure a first device to a second device, the locking apparatus comprising:
a positioning member attached to the first device;
a securing member rotatably attached to the second device; the securing member defining a guiding slot and a positioning slot communicating with the guiding slot;
wherein the positioning member extends through the guiding slot to engage in the positioning slot and secure the first device to the second device.

2. The locking apparatus of claim 1, wherein the securing member comprises a securing panel and a blocking panel connected to the securing panel, and the guiding slot and the positioning slot are defined in the securing panel.

3. The locking apparatus of claim 2, wherein the securing panel is substantially perpendicular to the blocking panel.

4. The locking apparatus of claim 2, wherein the securing member further comprises an operating tab extending substantially perpendicular from the securing panel.

5. The locking apparatus of claim 1, wherein a size of the guiding slot is greater than a size of the positioning slot.

6. The locking apparatus of claim 1, wherein the positioning member comprises a first positioning portion, a second positioning portion, and a first connecting portion connected to the first positioning portion and the second positioning portion, the first positioning portion and the first connecting portion are engaged in a positioning hole of the first device, and the second positioning portion is adapted to abut the first device.

7. The locking apparatus of claim 6, wherein the positioning member further comprises a third positioning portion and a second connecting portion connected to the second positioning portion and the third positioning portion, and a length of the second connecting portion is greater than a length of the first connecting portion.

8. The locking apparatus of claim 7, wherein a diameter of the first positioning portion is greater than a diameter of the second positioning portion.

9. The locking apparatus of claim 1, further comprising a mounting member, wherein a securing hole is further defined in the securing member, the mounting member is engaged in the securing hole and a fixing hole of the second device, to secure the securing member to the second device, and the securing member is rotatable about the mounting member.

10. A locking apparatus to secure a first device to a second device, the locking apparatus comprising:
a positioning member attached to the first device;
a securing member; the securing member defining a positioning slot;
a mounting member; the mounting member securing the securing member to the second device;
wherein the securing member is rotatable about the mounting member between a lock position and an unlock position, in the lock position, the positioning member is engaged in the positioning slot, for preventing the first device moving away from the second device, and in the unlock position, the positioning member is disengaged from the positioning slot.

11. The locking apparatus of claim 10, wherein the securing member further defines a guiding slot communicating with the positioning slot, and the positioning member extends through the guiding slot to engage in the positioning slot.

12. The locking apparatus of claim 11, wherein the securing member comprises a securing panel and a blocking panel connected to the securing panel, and the guiding slot and the positioning slot are defined in the securing panel.

13. The locking apparatus of claim 12, wherein the securing panel is substantially perpendicular to the blocking panel.

14. The locking apparatus of claim 12, wherein the securing member further comprises an operating tab extending substantially perpendicular from the securing panel.

15. The locking apparatus of claim 12, wherein a size of the guiding slot is greater than a size of the positioning slot.

16. The locking apparatus of claim 11, wherein the positioning member comprises a first positioning portion, a second positioning portion, and a first connecting portion connected to the first positioning portion and the second positioning portion, the first positioning portion and the first connecting portion are engaged in a positioning hole of the first device, and the second positioning portion is adapted to be abut the first device.

17. The locking apparatus of claim 16, wherein the positioning member further comprises a third positioning portion and a second connecting portion connected to the second positioning portion and the third positioning portion, and a length of the second connecting portion is greater than a length of the first connecting portion.

18. The locking apparatus of claim 17, wherein a diameter of the first positioning portion is greater than a diameter of the second positioning portion.

19. The locking apparatus of claim 10, wherein a securing hole is defined in the securing member, and the mounting member is engaged in the securing hole and a fixing hole of the second device, to secure the securing member to the second device.
